(19) United States
(12) Patent Application Publication
(10) Pub. No.: US 2004/0010060 A1
(43) Pub. Date: Jan. 15, 2004

(54) Vesicles comprising an amphiphilic di-block copolymer and a hydrophobic compound

(76) Inventors: Mathieu Joanicot, Chatenay-Malabry (FR); Ani Nikova, San Diego, CA (US); Maria Ruela Talingting, Burlington, NJ (US); David Weitz, Bolton, MA (US)

Correspondence Address: Jean-Louis Seugnet, RHODIA INC., Bldg. N-2, 259 Prospect Plains Road, CRANBURY, NJ, 08512-7500, US

(21) Appl. No.: 10/392,123

(22) Filed: Mar. 19, 2003

Related U.S. Application Data
(60) Provisional application No. 60/366,037, filed on Mar. 20, 2002.

(51) Int. Cl. C08F 2/00

(52) U.S. Cl. 523/201

(57) ABSTRACT

The invention relates to new vesicles structures, and their use for delivering actives. The vesicles according to the invention are obtained from di-block copolymers. The vesicles comprise an external shell of a di-block copolymer comprising a hydrophilic block and a hydrophobic block, and at least one internal shell of the same or another di-block copolymer comprising a hydrophilic block and a hydrophobic block, the hydrophobic block of the external shell facing the hydrophobic block of the internal shell(s), and further comprise a hydrophobic compound between the shells.

### CROSS REFERENCES TO RELATED APPLICATIONS

This application claims the priority under 35 U.S.C. 119 and/or 365 to No. 60/366,037 filed in the United States on Mar. 20, 2002, the entire content of which is hereby incorporated by reference.

### BACKGROUND OF THE INVENTION

The invention relates to new vesicles structures, and their use for delivering actives. The vesicles according to the invention are obtained from di-block copolymers.

Vesicles and their use for delivering hydrophilic actives are known. A classical vesicle is usually a bi-layer membrane of an amphiphilic compound comprising a hydrophobic moiety and a hydrophilic moiety. The membrane usually consists of an external layer of the amphiphilic compound, and an internal layer of the same amphiphilic compound, the hydrophobic moiety of the external layer facing the hydrophobic moiety of the internal layer. The membrane is a closed pocket wherein an aqueous media usually comprising a compound, such as an active, is trapped. Vesicles may be used for delivering, vectoring, protecting, and/or encapsulating compounds in many fields. These fields include delivering a compound in a human or animal body, encapsulating colored compounds . . . .

As amphiphilic compounds for making vesicles having the structure described above, phospholipids are known. Synthetic di-block copolymers are also known. For example Discher et al. describe using polyethyleneoxide-polyethylethylene [EO]₄₀-[EE]₃₇ block copolymers, in SCIENCE, may 1999, page 1143. They teach that using block copolymers allows controlling some properties of the membrane, such as mechanical properties. Yu et al. in Langmuir, 1999, 15, 7157-7167 describe using polystyrene-polyethyleneoxide block copolymers, and controlling the membrane structure. Shen et al. in J. Phys. Chem. B 1999, 103. 9473-9487 describe using polystyrene-polyacrylic acid [Styrene]₃₁₀-[AA]₅₂ block copolymers. Using polystyrene-polyacrylic acid block copolymers is also described by Yu et al. in Macromolecules, Vol 31, 1144-1154.

Vesicles are usually used for encapsulating a hydrophilic active. The active is to be released outside the membrane, by diffusion through the membrane and/or by destruction the membrane. There is a need for providing new membranes structures in order to broaden the scope of application wherein vesicles can be used, to control of actives release, or to broaden the scope of actives that may be encapsulated. In particular, there is a need for providing means to encapsulate non water-compatible actives, or to encapsulate both water-compatible and non water-compatible actives. There is also a need for vesicles having a strengthened membrane.

The invention relates to new vesicles structures, comprising a block copolymer, that provide for example new means for encapsulation, vectorization, protection, and/or release control of compounds.

### BRIEF SUMMARY OF THE INVENTION

The invention relates to vesicles comprising an external shell of a di-block copolymer comprising a hydrophilic block and a hydrophobic block, and at least one internal shell of the same or another di-block copolymer comprising a hydrophilic block and a hydrophobic block, the hydrophobic block of the external shell facing the hydrophobic block of the internal shell(s), further comprising a hydrophobic compound between the shells.

In another aspect, the invention relates to a process for making vesicles.

In a particular aspect, it relates to triple emulsion type compositions, wherein a hydrophobic phase is dispersed in a hydrophobic phase, which is a dispersed in an aqueous phase. It also relates to a process for making such triple emulsion type compositions.

In still another aspect, it relates to the use of vesicles as described above for encapsulating, vectorizing, protecting, and/or release control, of hydrophobic compounds, or both hydrophobic compounds and hydrophilic compounds. These vesicles may be used in pharmaceuticals, home-care formulations, personal care formulations, agricultural formulations, fabrics treatments formulations, or in other industrial fields.

### BRIEF DESCRIPTION OF DRAWINGS

FIG. 1 is an optical micrograph of the vesicles according to the invention.

FIG. 2 is an optical micrograph of the vesicles according to the invention.

FIG. 3 is a fluorescence microscopy image of a vesicle according to the invention showing a hydrophilic internal phase.

FIG. 4 is a fluorescence microscopy image of a vesicle according to the invention showing a hydrophobic compound being a polymer.

FIG. 5 is a fluorescence microscopy image of a vesicle according to the invention showing a hydrophobic compound being nanoparticles.

### DETAILED DESCRIPTION OF THE INVENTION

Definitions

In the present specification, the molecular weight of a polymer, copolymer or block refers to the weight-average molecular weight of said polymer, copolymer or block. The weight-average molecular weight of the polymer or copolymer can be measured by gel permeation chromatography (GPC). In the present specification, the molecular weight of a block refers to the molecular weight calculated from the amounts of monomers, polymers, initiators and/or transfer agents used to make the said block. The one skilled in the art knows how to calculate these molecular weights. The ratios by weight between blocks refer to the ratios between the amounts of the compounds used to make said blocks, considering an extensive polymerization.

Typically, the molecular weight M of a block is calculated according to the following formula:

$$M = {\sum }_{i} {M}_{i}^{*} \frac{{n}_{i}}{{n}_{precursor}} ,$$

wherein Mᵢ is the molecular weight of a monomer i, nᵢ is the number of moles of a monomer i, and n_{precusor} is the number of moles of a compound the macromolecular chain of the block will be linked to. Said compound may be a transfer agent or a transfer group, or a previous block. If it is a previous block, the number of moles may be considered as the number of moles of a compound the macromolecular chain of said previous block has been linked to, for example a transfer agent or a transfer group. It may be also obtained by a calculation from a measured value of the molecular weight of said previous block. If two blocks are simultaneously grown from a previous block, at both ends, the molecular weight calculated according to the above formula should be divided by two.

In the present specification, a unit deriving from a monomer is understood as a unit that may be directly obtained from the said monomer by polymerizing. Thus, a unit deriving from an ester of acrylic or methacrylic acid does not encompass a unit of formula —CH—CH(COOH)—, —CH—C(CH₃)(COOH)—, —CH—CH(OH)—, —CH—C(CH₃)(OH)—, obtained for example by polymerizing an ester of acrylic or methacrylic acid, or a vinyl acetate, and then hydrolyzing. A unit deriving from acrylic acid or methacrylic acid encompasses for example a unit obtained by polymerizing a monomer (for example an alkyl acrylate or methacylate) and then reacting (for example hydrolyzing) to obtain units of formula —CH—CH(COOH)— or —CH—C(CH₃)(COOH)—. A unit deriving from vinyl alcohol encompasses for example a unit obtained by polymerizing a monomer (for example a vinyl ester) and then reacting (for example hydrolyzing) to obtain units of formula —CH—CH(OH)— or —CH—C(CH₃)(OH)—.

The vesicles according to the invention comprise one or several di-block copolymer(s) and a hydrophobic compound. The di-block copolymer(s) is arranged in at least two shells, an external shell and at least one internal shell, surrounding the hydrophobic compound. It means that the hydrophobic compound is comprised in the space defined by said external shell and internal shell(s). The shells, together with the hydrophobic compound are also referred to as the membrane of the vesicle. As a vesicle bi-layer membrane usually consists of two layers (i.e. two shells) of an amphiphilic compound comprising a hydrophobic moiety and a hydrophilic moiety, the membrane of the vesicles according to the invention will be also referred to as a membrane swollen by the hydrophobic compound, or as a membrane stuffed with the hydrophobic compound.

The di-block copolymer(s) comprised in the shells comprises a hydrophilic block and a hydrophobic block. Thus, it is an amphiphilic block copolymer. It is further mentioned that the external shell and the internal shell(s) comprise identical or different block copolymers. Further details about the block copolymer are provided below. The hydrophobic shell of the external shell and the hydrophobic block of the internal shell(s) face one another, being in contact with the hydrophobic compound. The hydrophilic block of the external shell is usually in contact with an external hydrophilic medium (such as water or a composition comprising water) the vesicles are dispersed in. In other words, the hydrophobic block of the external shell usually faces an external hydrophilic medium the vesicles are dispersed in. The hydrophilic block of the internal shell(s) is usually in contact with an internal hydrophilic medium (such as water or a composition comprising water), inside the vesicle. In other words, the hydrophilic block of the internal shell(s) usually faces an internal hydrophilic medium inside the vesicles.

According to a first embodiment, the vesicles comprise only one internal shell. According to this embodiment the structure of the vesicles comprises the following:

a core comprising an internal hydrophilic medium, such as water or a composition comprising water, comprised inside a membrane, and

a membrane surrounding the core, comprising:

an internal shell, or internal layer, of a di-block copolymer, the hydrophilic block facing the core, and the hydrophobic block facing the intermediate layer mentioned below,

an intermediate layer comprising the hydrophobic compound, surrounding the internal shell, and

an external shell, or external layer, of a di-block copolymer, surrounding the intermediate layer, the hydrophobic block facing the intermediate layer.

The vesicles according to this embodiment are usually dispersed in a hydrophilic external medium, the hydrophilic block of the external shell facing said hydrophilic external medium, such as water or a composition comprising water. Vesicles according to this embodiment may be identified by images showing a hydrophilic internal phase being dispersed in a hydrophilic phase and by a hydrophobic phase or compound image being a ring.

Vesicles according to this embodiment usually comprise, or are preferably obtained with:

a di-block copolymer wherein the hydrophilic block comprises hydrophilic units, the hydrophobic block comprises hydrophobic units, the weight ratio between the amount of hydrophobic units and the hydrophilic units being comprised between 25/75 and 70/30, preferably between 50/50 and 70/30, and

a hydrophobic polymer, in a weight amount which is greater than or equal to 1%, preferably 3%, and lower than or equal to 15 wt %, preferably lower than or equal to 10%, relating to the amount of di-block copolymer.

Meanwhile it is preferred that the weight ratio between the amount of hydrophobic units comprises both in the hydrophobic block and in the hydrophobic polymer, and the amount of units comprised in the hydrophilic block, is of lower than 70/30.

According to a second embodiment, the vesicles comprise at least two internal shells. Vesicles according to this embodiment may also be referred to as multiple emulsion type vesicles. According to this embodiment the structure of the vesicles comprise the following:

droplets of an internal hydrophilic medium, such as water or a composition comprising water, each droplet being surrounded by an internal shell of a di-block copolymer, the hydrophilic block facing the droplets, and the hydrophobic block facing the hydrophobic phase mentioned below,

a hydrophobic phase comprising the hydrophobic compound, wherein the droplets are dispersed, and

an external shell of a di-block copolymer, surrounding the hydrophobic phase, the hydrophobic block facing the hydrophobic phase.

The vesicles according to this embodiment are usually dispersed in a hydrophilic external medium, such as water or a composition comprising water, the hydrophilic block of the external shell facing said hydrophilic external medium.

Vesicles according to the second embodiment, with the external hydrophilic medium, form triple emulsion compounds comprising an internal hydrophilic phase dispersed in a hydrophobic phase, said hydrophobic phase being dispersed in an external hydrophilic phase, and are obtained preferably by a process comprising the steps of:

a) depositing onto a surface a solution comprising the di-block copolymer and a hydrophobic polymer, dissolved in a solvent,

b) evaporating the solvent to obtain a dried thin film comprising the di-block copolymer and the hydrophobic polymer, and

c) rehydrating the thin film, and wherein:

the external hydrophilic phase comprises the external hydrophilic medium,

the hydrophilic phase comprises the hydrophobic compound between the shells, and

the internal hydrophilic phase comprises the internal hydrophilic medium.

This process is a typical film rehydratation process for making vesicles. It is an alternative to other processes for making triple emulsion compositions, that usually involve preparing a first water in oil emulsion, and then preparing a second emulsion of the first emulsion in water. As other processes may be difficult to carry out, and as it may be difficult to obtain triple emulsions of particular phases by said other processes, the above process makes it possible to obtain new triple emulsion compositions, or triple emulsion compositions comprising new actives or new combinations of actives.

Vesicles according to this embodiment embodiment preferably comprise, or are preferably obtained with:

a di-block copolymer wherein the hydrophilic block comprises hydrophilic units, the hydrophobic block comprises hydrophobic units, the weight ratio between the amount of hydrophobic units and the hydrophilic units being comprised between 25/75 and 70/30, preferably between 50/50 and 70/30, and

a hydrophobic polymer, in a weight amount which is greater than or equal to 10%, preferably greater than or equal to 15%, relating to the amount of di-block copolymer.

It is further mentioned that it is difficult to control extensively whether vesicles according to the first embodiment or to the second embodiment will be obtained. Thus vesicles according to the invention encompass mixtures of vesicles according to the first and to the second embodiment.

Di-Block Copolymer

The di-block copolymer(s) comprises a hydrophilic block and a hydrophobic block. A block may be a block having a comb polymer structure, that is comprising repeating units comprising a polymeric moiety (macromonomers). Below the hydrophilic block is referred to as block A, and the hydrophobic block is referred to as block B.

A block is usually defined by repeating units it comprises. A block may be a copolymer, comprising several kind of repeating units, deriving form several monomers. Hence, block A and block B are different polymers, deriving from different monomers, but they may comprise some common repeating units (copolymers). Block A and block B preferably do not comprise more than 50% of a common repeating unit (derived from the same monomer).

Block A is hydrophilic and block B is hydrophobic. Hydrophilic or Hydrophobic properties of a block refer to the property said block would have without the other block, that is the property of a polymer consisting of the same repeating units than said block, having the same molecular weight. By hydrophilic block, polymer or copolymer, it is meant that the block, polymer or copolymer does not phase separate macroscopically in water at a concentration from 0.01% and 10% by weight, at a temperature from 20° C. to 30° C. By hydrophobic block, polymer or copolymer, it is meant that the block, polymer or copolymer does phase separate macroscopically in the same conditions.

It is further mentioned that the block copolymer may be soluble in water, ethanol, THF, and/or in a hydrophobic compound.

Preferably, block B comprises repeating units deriving from monomers selected from the group consisting of:

propylene oxide,

alkylesters of an alpha-ethylenically-unsaturated, preferably mono-alpha-ethylenically-unsaturated, monocarboxylic acid, such as methylacrylate, ethylacrylate, n-propylacrylate, n-butylacrylate, methylmethacrylate, ethylmethacrylate, n-propylmethacrylate, n-butylmethacrylate, and 2-ethyl-hexyl acrylate, 2-ethyl-hexyl methacrylate, isooctyl acrylate, isooctyl methacrylate, lauryl acrylate, lauryl methacrylate,

vinyl Versatate,

acrylonitrile,

vinyl nitriles, comprising from 3 to 12 carbon atoms,

vinylamine amides, and

vinylaromatic compounds such as styrene.

Preferably, block A comprises repeating units deriving from monomers selected from the group consisting of:

ethylene oxide,

vinyl alcohol,

vinyl pyrrolidone,

acrylamide, methacrylamide,

polyethylene oxide (meth)acrylate (i.e. polyethoxylated (meth)acrylic acid),

hydroxyalkylesters of alpha-ethylenically-unsaturated, preferably mono-alpha-ethylenically-unsaturated, monocarboxylic acids, such as 2-hydroxyethylacrylate, and

hydroxyalkylamides of alpha-ethylenically-unsaturated, preferably mono-alpha-ethylenically-unsaturated, monocarboxylic acids,

dimethylaminoethyl (meth)acrylate, dimethylaminopropyl (meth)acrylate, ditertiobutylaminoethyl (meth)acrylate, dimethylaminomethyl (meth)acrylamide, dimethylaminopropyl (meth)acrylamide;

ethylenimine, vinylamine, 2-vinylpyridine, 4-vinylpyridine;

trimethylammonium ethyl (meth)acrylate chloride, trimethylammonium ethyl (meth)acrylate methyl sulphate, dimethylammonium ethyl (meth)acrylate benzyl chloride, 4-benzoylbenzyl dimethylammonium ethyl acrylate chloride, trimethyl ammonium ethyl (meth)acrylamido (also called 2-(acryloxy)ethyltrimethylammonium, TMAEAMS) chloride, trimethylammonium ethyl (meth)acrylate (also called 2-(acryloxy)ethyltrimethylammonium, TMAEAMS) methyl sulphate, trimethyl ammonium propyl (meth)acrylamido chloride, vinylbenzyl trimethyl ammonium chloride,

diallyldimethyl ammonium chloride,

alpha-ethylenically-unsaturated, preferably mono-alpha-ethylenically-unsaturated, monomers comprising a phosphate or phosphonate group,

alpha-ethylenically-unsaturated, preferably mono-alpha-ethylenically-unsaturated, monocarboxylic acids, such as acrylic acid, methacrylic acid

monoalkylesters of alpha-ethylenically-unsaturated, preferably mono-alpha-ethylenically-unsaturated, dicarboxylic acids,

monoalkylamides of alpha-ethylenically-unsaturated, preferably mono-alpha-ethylenically-unsaturated, dicarboxylic acids,

alpha-ethylenically-unsaturated, preferably mono-alpha-ethylenically-unsaturated, compounds comprising a sulphonic acid group, and salts of alpha-ethylenically-unsaturated, preferably mono-alpha-ethylenically-unsaturated, compounds comprising a sulphonic acid group, such as vinyl sulphonic acid, salts of vinyl sulfonic acid, vinylbenzene sulphonic acid, salts of vinylbenzene sulphonic acid, alpha-acrylamidomethylpropanesulphonic acid, salts of alpha-acrylamidomethylpropanesulphonic acid 2-sulphoethyl methacrylate, salts of 2-sulphoethyl methacrylate, acrylamido-2-methylpropanesulphonic acid (AMPS), salts of acrylamido-2-methylpropanesulphonic acid, and styrenesulfonate (SS)

Block A more preferably comprises units deriving from monomers selected from the group consisting of:

acrylic acid, methacrylic acid,

acrylamide, methacrylamide,

vinyl sulphonic acid, salts of vinyl sulfonic acid,

vinylbenzene sulphonic acid, salts of vinylbenzene sulphonic acid,

alpha-acrylamidomethylpropanesulphonic acid, salts of alpha-acrylamidomethylpropanesulphonic acid

2-sulphoethyl methacrylate, salts of 2-sulphoethyl methacrylate,

acrylamido-2-methylpropanesulphonic acid (AMPS), salts of acrylamido-2-methylpropanesulphonic acid, and

styrenesulphonate (SS).

While block B is usually a neutral block, block A might be discriminated as regard to its electrical behavior or nature. It means that block A may be a neutral block, or a polyionic block (a polyanionic block, or a polycationic block). It is further mentioned the electrical behavior or nature (neutral, polyanionic or polycationic) may depend on the pH of the emulsion. By polyionic it is meant that the block comprises ionic (anionic or cationic) repetitive units whatever the pH, or that the block comprises repetitive units that may be neutral or ionic (anionic or cationic) depending on the pH of the emulsion (the units are potentially ionic). A unit that may be neutral or ionic (anionic or cationic), depending on the pH of the composition, will be thereafter referred as an ionic unit (anionic or cationic), or as a unit deriving from an ionic monomer (anionic or cationic), whatever it is in a neutral form or in an ionic form (anionic or cationic).

Examples of polycationic blocks are blocks comprising units deriving from cationic monomers such as:

aminoalkyl (meth)acrylates, aminoalkyl (meth)acrylamides,

monomers, including particularly (meth)acrylates, and (meth)acrylamides derivatives, comprising at least one secondary, tertiary or quaternary amine function, or a heterocyclic group containing a nitrogen atom, vinylamine or ethylenimine;

diallyldialkyl ammonium salts;

their mixtures, their salts, and macromonomers deriving from therefrom.

Examples of cationic monomers include:

dimethylaminoethyl (meth)acrylate, dimethylaminopropyl (meth)acrylate, ditertiobutylaminoethyl (meth)acrylate, dimethylaminomethyl (meth)acrylamide, dimethylaminopropyl (meth)acrylamide;

ethylenimine, vinylamine, 2-vinylpyridine, 4-vinylpyridine;

trimethylammonium ethyl (meth)acrylate chloride, trimethylammonium ethyl (meth)acrylate methyl sulphate, dimethylammonium ethyl (meth)acrylate benzyl chloride, 4-benzoylbenzyl dimethylammonium ethyl acrylate chloride, trimethyl ammonium ethyl (meth)acrylamido (also called 2-(acryloxy)ethyltrimethylammonium, TMAEAMS) chloride, trimethylammonium ethyl (meth)acrylate (also called 2-(acryloxy)ethyltrimethylammonium, TMAEAMS) methyl sulphate, trimethyl ammonium propyl (meth)acrylamido chloride, vinylbenzyl trimethyl ammonium chloride,

diallyidimethyl ammonium chloride,

monomers having the following formula:

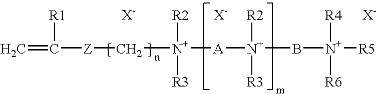

wherein

R₁ is a hydrogen atom or a methyl or ethyl group;

R₂, R₃, R₄, R₅ and R₆, which are identical or different, are linear or branched C₁-C₆, preferably C₁-C₄, alkyl, hydroxyalkyl or aminoalkyl groups;

m is an integer from 1 to 10, for example 1;

n is an integer from 1 to 6, preferably 2 to 4;

Z represents a —C(O)O— or —C(O)NH— group or an oxygen atom;

A represents a (CH₂)p group, p being an integer from 1 to 6, preferably from 2 to 4;

B represents a linear or branched C₂-C₁₂, advantageously C₃-C₆, polymethylene chain optionally interrupted by one or more heteroatoms or heterogroups, in particular O or NH, and optionally substituted by one or more hydroxyl or amino groups, preferably hydroxyl groups;

X, which are identical or different, represent counterions, and

their mixtures, and macromonomers deriving therefrom.

Examples of anionic blocks are blocks comprising units deriving from anionic monomers selected from the group consisting of:

alpha-ethylenically-unsaturated, preferably mono-alpha-ethylenically-unsaturated, monomers comprising a phosphate or phosphonate group,

alpha-ethylenically-unsaturated, preferably mono-alpha-ethylenically-unsaturated, monocarboxylic acids,

monoalkylesters of alpha-ethylenically-unsaturated, preferably mono-alpha-ethylenically-unsaturated, dicarboxylic acids,

monoalkylamides of alpha-ethylenically-unsaturated, preferably mono-alpha-ethylenically-unsaturated, dicarboxylic acids,

alpha-ethylenically-unsaturated, preferably mono-alpha-ethylenically-unsaturated, compounds comprising a sulphonic acid group, and salts of alpha-ethylenically-unsaturated compounds comprising a sulphonic acid group.

Preferred anionic blocks include blocks comprising deriving from at least one anionic monomer selected from the group consisting of:

acrylic acid, methacrylic acid,

vinyl sulphonic acid, salts of vinyl sulfonic acid,

vinylbenzene sulphonic acid, salts of vinylbenzene sulphonic acid,

alpha-acrylamidomethylpropanesulphonic acid, salts of alpha-acrylamidomethylpropanesulphonic acid

2-sulphoethyl methacrylate, salts of 2-sulphoethyl methacrylate,

acrylamido-2-methylpropanesulphonic acid (AMPS), salts of acrylamido-2-methylpropanesulphonic acid, and

styrenesulfonate (SS).

Examples of neutral blocks (block A or block B) are blocks comprising units deriving from at least one monomer selected from the group consisting of:

acrylamide, methacrylamide,

amides of alpha-ethylenically-unsaturated, preferably mono-alpha-ethylenically-unsaturated, monocarboxylic acids,

esters of an alpha-ethylenically-unsaturated, preferably mono-alpha-ethylenically-unsaturated, monocarboxylic acid, for example alkyl esters such as such as methylacrylate, ethylacrylate, n-propylacrylate, n-butylacrylate, methylmethacrylate, ethylmethacrylate, n-propylmethacrylate, n-butylmethacrylate, 2-ethyl-hexyl acrylate, or hydroxyalkyl esters such as 2-hydroxyethylacrylate,

polyethylene and/or polyporpylene oxide (meth)acrylates (i.e. polyethoxylated and/or polypropoxylated (meth)acrylic acid),

vinyl alcohol,

vinyl pyrrolidone,

vinyl acetate, vinyl Versatate,

vinyl nitriles, preferably comprising from 3 to 12 carbon atoms,

acrylonitrile,

vinylamine amides,

vinyl aromatic compounds, such as styrene, and

mixtures thereof.

Block A preferably derives from mono-alpha-ethylenically unsaturated monomers. Block B preferably derives from mono-alpha-ethylenically unsaturated monomers. In a preferred embodiment, both block A and block B derive from mono-alpha-ethylenically unsaturated monomers. More precisely, it is meant that for block A and/or block B, at least 50% of the repeating units preferably are mono-alpha-ethylenically-unsaturated monomers derived units.

The monomers listed above are mono-alpha-unsaturated monomers, except propylene oxide and ethylene oxide.

In a preferred embodiment, block A is a polyacrylic acid, a polymethacrylic acid block, or a salt thereof. In a preferred embodiment, block B is a polybutylacrylate block, or a polybutylmethacrylate block. In a more preferred embodiment, block A is a polyacrylic acid block and block B is a polybutylacrylate block (p(BA)-p(AA) di-block copolymer).

The weight-average molecular weight of the block copolymer is preferably comprised between 1000 and 100000 g/mol. It is more preferably comprised between 2000 and 20000 g/mol. Within these ranges, the weight ratio of each block may vary. It is however preferred that each block has a molecular weight above 500 g/mol, and preferably above 1000 g/mol. Within these ranges, the weight ratio of block B in the copolymer is preferably greater than or equal to 25%, and more preferably greater than or equal to 50%, and preferably lower than or equal to 70%.

There are several methods for making block copolymers. Some methods for making such copolymers are provided below.

It is possible for example to use anionic polymerization with sequential addition of 2 monomers as described for example by Schmolka, J. Am. Oil Chem. Soc. 1977, 54, 110; or alternatively Wilczek-Veraet et al., Macromolecules 1996, 29, 4036. Another method which can be used consists in initiating the polymerization of a block polymer at each of the ends of another block polymer as described for example by Katayose and Kataoka, Proc. Intern. Symp. Control. Rel. Bioact. Materials, 1996, 23, 899.

In the context of the present invention, it is recommended to use living or controlled polymerization as defined by Quirk and Lee (Polymer International 27, 359 (1992)). Indeed, this particular method makes it possible to prepare polymers with a narrow dispersity and in which the length and the composition of the blocks are controlled by the stoichiometry and the degree of conversion. In the context of this type of polymerization, there are more particularly recommended the copolymers which can be obtained by any so-called living or controlled polymerization method such as, for example:

free-radical polymerization controlled by xanthates according to the teaching of Application WO 98/58974 and U.S. Pat. No. 6,153,705,

free-radical polymerization controlled by dithioesters according to the teaching of Application WO 98/01478,

free-radical polymerization controlled by dithioesters according to the teaching of Application WO 99/35178,

free-radical polymerization controlled by dithiocarbamates according to the teaching of Application WO 99/35177,

free-polymerization using nitroxide precursors according to the teaching of Application WO 99/03894,

free-radical polymerization controlled by dithiocarbamates according to the teaching of Application WO 99/31144,

free-radical polymerization controlled by dithiocarbazates according to the teaching of Application WO 02/26836,

free-radical polymerization controlled by halogenated Xanthates according to the teaching of Application WO 00/75207 and U.S. application Ser. No. 09/980,387,

free-radical polymerization controlled by dithiophosphoroesters according to the teaching of Application WO 02/10223,

free-radical polymerization controlled by a transfer agent in the presence of a disulphur compound according to the teaching of Application WO 02/22688,

atom transfer radical polymerization (ATRP) according to the teaching of Application WO 96/30421,

free-radical polymerization controlled by iniferters according to the teaching of Otu et al., Makromol. Chem. Rapid. Commun., 3, 127 (1982),

free-radical polymerization controlled by degenerative transfer of iodine according to the teaching of Tatemoto et al., Jap. 50, 127, 991 (1975), Daikin Kogyo Co Ltd Japan, and Matyjaszewski et al., Macromolecules, 28, 2093 (1995),

group transfer polymerization according to the teaching of Webster O. W., “Group Transfer Polymerization”, p. 580-588, in the “Encyclopedia of Polymer Science and Engineering”, Vol. 7, edited by H. F. Mark, N. M. Bikales, C. G. Overberger and G. Menges, Wiley Interscience, New York, 1987,

radical polymerization controlled by tetraphenylethane derivatives (D. Braun et al., Macromol. Symp., 111, 63 (1996)),

radical polymerization controlled by organocobalt complexes (Wayland et al., J. Am. Chem. Soc., 116, 7973 (1994)).

Preferred processes are sequenced living free-radical polymerization processes, involving the use of a transfer agent. Preferred transfer agents are agents comprising a group of formula —S—C(S)—Y—, —S—C(S)—S—, or —S—P(S)—Y—, or —S—P(S)—S—, wherein Y is an atom different from sulfur, such as an oxygen atom, a nitrogen atom, and a carbon atom. They include dithioester groups, thioether-thione groups, dithiocarbamate groups, dithiphosphoroesters, dithiocarbazates, and xanthate groups. Examples of groups comprised in preferred transfer agents include groups of formula —S—C(S)—NR—NR′₂, —S—C(S)—NR—N═CR′₂, —S—C(S)—O—R, —S—C(S)—CR═CR′₂, and —S—C(S)—X, wherein R and R′ are or identical or different hydrogen atoms, or organic groups such as hydrocarbyl groups, optionally substituted, optionally comprising heteroatoms, and X is an halogen atom. A preferred polymerization process is a living radical polymerization using xanthates.

Copolymers obtained by a living or controlled free-radical polymerization process may comprise at least one transfer agent group at an end of the polymer chain. In particular embodiment such a group is removed or deactivated.

For example, a “living” or “controlled” radical polymerization process used to make the di-block copolymers comprises the steps of:

a) reacting a mono-alpha-ethylenically-unsaturated monomer, at least a free radicals source compound, and a transfer agent, to obtain a first block, the transfer agent being bounded to said first block,

b) reacting the first block, another mono-alpha-ethylenically-unsaturated monomer, and, optionally, at least a radical source compound, to obtain a di-block copolymer, and then

c) optionally, reacting the transfer agent with means to render it inactive.

During step a), a first block of the polymer is synthesized. During step b), b1), or b2), another block of the polymer is synthesized.

Examples of transfer agents are transfer agents of the following formula (I):

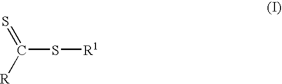

wherein:

R represents an R²O—, R²R′²N— or R³— group, R² and R′², which are identical or different, representing (i) an alkyl, acyl, aryl, alkene or alkyne group or (ii) an optionally aromatic, saturated or unsaturated carbonaceous ring or (iii) a saturated or unsaturated heterocycle, it being possible for these groups and rings (i), (ii) and (iii) to be substituted, R³ representing H, Cl, an alkyl, aryl, alkene or alkyne group, an optionally substituted, saturated or unsaturated (hetero)cycle, an alkylthio, alkoxycarbonyl, aryloxycarbonyl, carboxyl, acyloxy, carbamoyl, cyano, dialkyl- or diarylphosphonato, or dialkyl- or diarylphosphinato group, or a polymer chain,

R¹ represents (i) an optionally substituted alkyl, acyl, aryl, alkene or alkyne group or (ii) a carbonaceous ring which is saturated or unsaturated and which is optionally substituted or aromatic or (iii) an optionally substituted, saturated or unsaturated heterocycle or a polymer chain, and

The R¹, R², R′² and R³ groups can be substituted by substituted phenyl or alkyl groups, substituted aromatic groups or the following groups: oxo, alkoxycarbonyl or aryloxycarbonyl (—COOR), carboxyl (—COOH), acyloxy (—O₂CR), carbamoyl (—CONR₂), cyano (—CN), alkylcarbonyl, alkylarylcarbonyl, arylcarbonyl, arylalkylcarbonyl, isocyanato, phthalimido, maleimido, succinimido, amidino, guanidino, hydroxyl (—OH), amino (—NR₂), halogen, allyl, epoxy, alkoxy (—OR), S-alkyl, S-aryl or silyl, groups exhibiting a hydrophilic or ionic nature, such as alkaline salts of carboxylic acids or alkaline salts of sulphonic acid, poly(alkylene oxide) (PEO, PPO) chains, or cationic substituents (quaternary ammonium salts), R representing an alkyl or aryl group.

Preferably, the transfer agent of formula (I) is a dithiocarbonate chosen from the compounds of following formulae (IA), (IB) and (IC):

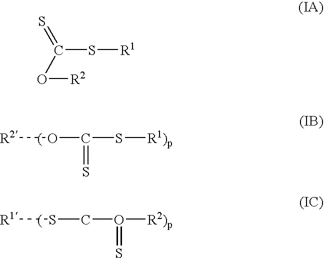

wherein:

R² and R₂′ represent (i) an alkyl, acyl, aryl, alkene or alkyne group or (ii) an optionally aromatic, saturated or unsaturated carbonaceous ring or (iii) a saturated or unsaturated heterocycle, it being possible for these groups and rings (i), (ii) and (iii) to be substituted,

R¹ and R¹′ represent (i) an optionally substituted alkyl, acyl, aryl, alkene or alkyne group or (ii) a carbonaceous ring which is saturated or unsaturated and which is optionally substituted or aromatic or (iii) an optionally substituted, saturated or unsaturated heterocycle or a polymer chain, and

p is between 2 and 10.

Other examples of transfer agents are transfer agents of the following formulae (II) and (III):

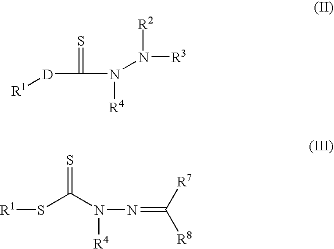

wherein

R¹ is an organic group, for example a group R¹ as defined above for tranfer agents of formulae (I), (IA), (IB), and (IC),

R², R³, R⁴, R⁷, and R⁸ which are identical or different are hydrogen atoms or organic groups, optionally forming rings. Examples of R², R³, R⁴, R⁷, and R⁸ organic groups include hydrocarbyls, subsituted hydrocabyls, heteroatom-containing hydrocarbyls, and substututed heteroatom-containing hydrocarbyls.

The mono-alpha-ethylenically-unsaturated monomers and their proportions are chosen in order to obtain the desire properties for the block(s). According to this process, if all the successive polymerizations are carried out in the same reactor, it is generally preferable for all the monomers used during one stage to have been consumed before the polymerization of the following stage begins, therefore before the new monomers are introduced. However, it may happen that monomers of the preceding stage are still present in the reactor during the polymerization of the following block. In this case, these monomers generally do not represent more than 5 mol % of all the monomers.

The polymerization can be carried out in an aqueous and/or organic solvent medium. The polymerization can also be carried out in a substantially neat melted form (bulk polymerization), or according to a latex type process in an aqueous medium.

Hydrophobic Compound

The hydrophobic compound is comprised between the shells. Examples include hydrophobic polymers, and hydrophobic inorganic particles.

In an embodiment the hydrophobic compound is hydrophobic inorganic particles, for example hydrophobic nanoparticles. The particles may be considered as being dispersed in the membrane, inside the hydrophobic block(s) of the di-block copolymer(s). Examples of useful nanoparticles include hydrophobic TiO₂, optionally coated or treated, cerium oxide nanoparticles, optionally coated or treated, and any pharmaceutical active hydrophobic nanoparticles.

The hydrophobic compound is preferably a hydrophobic polymer. Hydrophobic is understood as defined above. The vesicles according to this embodiment usually have a strengthen membrane. Having such a strengthened membrane allows easier formulation by preventing destruction when processing, or allows controlled release (long lasting). Hydrophobic polymers include polymers comprising repeating units deriving from monomers listed above for block B.

In a preferred embodiment the hydrophobic polymer and the hydrophobic block (block B) are the same. It means that they comprise units deriving from the same monomers. Thus, in an preferred embodiment, the hydrophobic block (block B) and the hydrophobic polymer are polybutylacrylate based or polybutylmethacrylate based. They may have the same or different molecular weights. According to this preferred embodiment, the hydrophobic polybutylacrylate or polybutylmehtacrylate have a weight-average molecular weight of between 5000 g/mol and 15000 g/mol.

It is further mentioned that when the hydrophobic compound is a polymer, said polymer may comprise means for cross-linking. Cross-linking the hydrophobic compound is for example a method for controlling the strength or the membrane or to control release of an active through or from the membrane.

Actives

The vesicles according to the invention may comprise active ingredients. Vesicles are usually comprised in a composition that has a destination such as being introduced in an animal or human body, applied onto a surface such as skin, hair, a fabric surface, or a hard surface, or spread in a field. Active ingredients are compounds comprised in the composition to be delivered, quickly or slowly, suddenly for example by breaking the membrane or progressively for example by diffusing through the membrane, in the destination environment. Thus vesicles may comprise actives useful in cosmetic compositions, drug compositions, perfumes, agrochemical compositions, fabrics treatments compositions.

The active ingredients may be comprised in the hydrophobic compound, more exactly in the membrane, according to the embodiment wherein the vesicles comprise only one internal shell, or in the hydrophobic phase comprising the hydrophobic compound, according to the embodiment wherein the vesicles comprises more than one internal shell. These active ingredients are preferably hydrophobic actives. They may be dispersed or dissolved in the hydrophobic compound.

The active ingredients may be comprised in the internal hydrophilic medium, more exactly in the core comprising an internal hydrophilic medium, according to the embodiment wherein the vesicles comprise only one internal shell, or in droplets of an internal hydrophilic medium, according to the embodiment wherein the vesicles comprise more than one internal shell. These active ingredients are preferably hydrophilic actives. They may be dispersed or dissolved in the internal hydrophilic medium, for example dispersed or dissolved in water or a composition comprising water.

Both the internal hydrophilic medium and the hydrophobic compound may comprise active ingredients, as described above.

It is mentioned that the hydrophobic compound may be considered itself as an active.

Active ingredients that may be comprised, for example dispersed or dissolved, in the hydrophobic compound include organic or inorganic compounds. Inorganic compounds are for example inorganic particles, such as nanoparticles, said particles having optionally a surface treatment for control the compatibility and/or dispersion, in and/or within the hydrophobic compound. The hydrophobic compound may also encompass the active inorganic particles.

Actives comprised in the hydrophobic compound may be in a liquid form, or in another form, in solution in the hydrophobic compound, or in an organic wherein the hydrophobic compound is miscible.

Preferably the actives being the hydrophobic compound, or being comprised therein are those whose solubility in water is not greater than 10 weight % at 25° C.

Examples of actives being the hydrophobic compound, or being comprising therein, that may be used in food industry include actives used in food industry include mono-, di- and triglycerides, essential oils, aromas, and food compatible coloring agents.

Examples of actives being the hydrophobic compound, or being comprising therein, that may be used in cosmetics include fragrances, perfumes, silicone oils, such as dimethicones, lipophilic vitamins such as A vitamin.

Examples of actives being the hydrophobic compound, or being comprising therein, that may be used in paints, include alkydes resins, epoxy resins, (poly)isocyanates masked or not masked.

Examples of actives being the hydrophobic compound, or being comprising therein, that may be used in paper industry include alkylcetene dimer (AKD), and alkenyl succinic anhydride (ASA).

Examples of actives being the hydrophobic compound, or being comprising therein, that may be used in agrochemicals include α-cyano-phénoxybenzyl carboxylates, α-cyano-halogénophénoxy-carboxylates, N-méthylcarbonates comprising aromatic groups, Aldrin, Azinphos-methyl, Benfluralin, Bifenthrin, Chlorphoxim, Chlorpyrifos, Fluchloralin, Fluroxypyr, Dichlorvos, Malathion, Molinate, Parathion, Permethrin, Profenofos, Propiconazole, Prothiofos, Pyrifenox, Butachlor, Metolachlor, Chlorimephos, Diazinon, Fluazifop-P-butyl, Heptopargil, Mecarbam, Propargite, Prosulfocarb, Bromophos-ethyl, Carbophenothion, and Cyhalothrin.

Examples of actives being the hydrophobic compound, or being comprising therein, that may be used in detergency compositions include silicone antifoaming agents, fragrances and perfumes.

Examples of actives being the hydrophobic compound, or being comprising therein, also include organic solvents or mixtures thereof, such as solvent used for cleaning or stripping such as aromatic oil cuts, terpenic compounds such as D- or L-limonenes, and solvents such as Solvesso®. Solvents also include aliphatic esters such as methyl esters of a mixture of acetic acid, succinic acid, glutaric acid (mixture of Nylon monomer preparation by-products), and chlorinated solvents.

Active ingredients that may be comprised in the internal hydrophilic medium include organic or inorganic compounds. Any hydrophilic active that may be introduced in a classical vesicle, known by the one skilled in the art, may be used.

Actives in the internal hydrophilic medium (preferably water-based), may be soluble in water. They may be solubilized in a hydrophilic solvent that is miscible with water, such as methanol, ethanol, propylene glycol, glycerol. Actives may also be in a solid form, dispersed in the hydrophilic medium; such as water or a composition comprising water.

Examples of actives comprised in the hydrophilic internal medium, include compounds having a cosmetic effect, a therapeutic effect, and compounds used for treating hair or skin.

Thus, active compounds that may be used include hair and skin conditioning agents, such as polymers comprising quaternary ammonium groups, optionally comprised in heterocycles (quaternium or polyquaternium type compounds), moisturizing agents, fixing (styling) agents, more preferably fixing polymers such as homo-, co-, or ter-polymers, for example acrylamide, acrylamide/sodium acrylate, sulfonated polystyrene, cationic polymers, polyvinylpyrrolidone, polyvinyl acetate . . . .

Actives that may be comprised in the hydrophilic internal medium also include coloring agents, astringents, that may be used in deodorizing compositions, such as aluminum salts, zirconium salts, antibacterial agents, anti-inflammatory agents, anesthetizing agents, solar filter agents . . . .

Actives comprised in the hydrophilic internal medium, that may be used in cosmetics, include α- and β-hydroxyacids, such as citric-acid, lactic acid, glycolic acid, salicylic acid, cicarboxylic acids, preferably unsaturated ones comprising from 9 to 16 carbon atoms, such as azelaic acid, C vitamin and drivatives thereof, particularly phophate-based or glycosyl-based derivatives, biocidal agents, such as preferably cationic ones (for example Glokill PQ, Rhodoaquat RP50, marketed by Rhodia).

Examples of actives comprised in the hydrophilic internal medium, that may be used in food industry, include divalent calcium salts (phosphates, chlorides . . . ), that may be used for cross-linking texturing polymers such as alginates, carraghenans. Sodium bicarbonate may also be used.

Examples of actives comprised in the hydrophilic internal medium, that may be used in agrochemicals, include hydrophilic pesticides and pesticides hydrophilic nutritive ingredients.

Examples of actives comprised in the hydrophilic internal medium, that may be used in oil fields, include hydrophilic compounds useful for cementing, drilling, or stimulating oil wells (for example par fracturing). Examples include cross-linking catalysts such as lithium salts, chlorides, acetate. Examples also include compounds that degrade polysaccharides, such as carboxylic acids (for example citric acid), enzymes, and oxidizing agents.

Examples of actives comprised in the hydrophilic internal medium, that may be used in paper industry include calcium chloride, and hydrochloric acid.

The hydrophobic compounds and the internal hydrophilic medium may comprise some further compounds to control osmotic pressures in the vesicle and/or to control the stability of the vesicles. For example the internal hydrophilic medium may comprise salts such as halides or sulfates of alkali or alkaline-earth metals (for example sodium chloride, calcium chloride, calcium sulfate) or mixtures thereof. The internal hydrophilic medium may also be or comprise a sugar such as glucose or at least polysaccharide, such as a dextran, or a mixture thereof.

The vesicles according to the invention may be prepared by a thin film rehydratation process. The vesicles obtained by this process are dispersed in an aqueous medium. The process include the steps of:

a) depositing onto a surface a solution comprising the di-block copolymer dissolved in a solvent, and the hydrophobic compound dispersed or dissolved in the solvent, preferably a hydrophobic polymer dissolved in the solvent,

b) evaporating the solvent to obtain a dried thin film comprising the di-block copolymer and the hydrophobic polymer, and

c) rehydrating the thin film, with water or a composition comprising water.

A suspension, dispersion or emulsion, of the vesicles in water, or in the composition comprising water is obtained. It is optionally further extruded through a membrane comprising pore, for example de polycarbonate membrane comprising pores. Such an extrusion step is known by the one skilled in the art of vesicles, for example in pharmaceutical industry for preparation of monodispersed phospholipid-based vesicles. This allows obtaining smaller vesicles with a narrower size dispersion. It also allows strengthening the vesicle membrane. It is found that, usually, the more hydrophobic polymer the vesicle comprises, the stronger the vesicle membrane is.

As the vesicles may comprise actives, it is mentioned that a hydrophobic active is usually introduced by introducing it in the solution, and that a hydrophilic active is usually introduced by introducing it in a composition comprising water when rehydrating the thin film.

As mentioned above, vesicles comprising only one internal shell or vesicles comprising several internal shells, may be obtained by the process. Usually, a small amount of hydrophobic polymer leads to vesicles comprising only one internal shell, and a large amount of hydrophobic compound leads to vesicles comprising several internal shells (triple emulsions type compositions). Again, a mixture according to the two embodiments may be obtained. Amounts of hydrophobic compounds and ratios between the hydrophobic block and hydrophilic block that be used have been mentioned above.

Properties

Vesicles according to the invention allow controlling the membrane (comprising the di-block copolymer, the hydrophobic compound, and optionally at least one active compound) properties. The controlled properties include strength, life-time, permeability, diffusion parameters for actives . . . . Thus, the membrane is stronger with the hydrophobic compound than without, and the more hydrophobic compound the vesicles comprise, the stronger the membrane is. Controlling the strength allows for example

adapting the vesicles to the destination medium it will be used in,

processing the vesicle to introduce them in a composition, such as a cosmetic composition, a detergent composition, a coating composition for fabrics (if vesicles are not strong enough, they may be destroyed while processed), and

controlling active(s) release timing, the actives being delivered once the membrane is destroyed.

Vesicles according to the invention are particularly useful to deliver actives, or to allow introducing actives in a medium wherein they are not compatible. The vesicles find uses in cosmetic compositions, detergent compositions, for example to provide said compositions with a perfume or fragrance active that resists to a wash. They also find uses in fabrics treatments, for example for releasing actives that provide effects (antibacterial effect, medical effects, “feel good” effects such as anti-stress, refreshing effect, hydrophilizing effect, cosmetic feel effect . . . ) during a long time, and/or after several washes. They also find use in pharmaceutical compositions.

Actives may be hydrophobic actives and/or hydrophilic actives as explained above. Examples of actives have been provided above. Vesicles according to the invention are particularly useful, since they may comprise both a hydrophilic active and a hydrophobic active. Thus, they may comprise actives that are usually comprised in vesicles, and a further hydrophobic active. That may avoid using another mean for introducing an hydrophobic compound in a composition comprising vesicles that comprise a hydrophilic active. That may ease obtaining “two-in-one” compositions, since some actives may not be compatible.

Some illustrative but non-limiting examples are provided hereunder for the better understanding of the invention.

### EXAMPLES

Compounds used:

Di-block copolymer 1: a polybutylacrylate-polyacrylic acid (PBA-b-PAA) block copolymer, having a weight-average molecular weight of 15,000 g/mol, comprising 50 wt % of the polybutylacrylate block and 50 wt % of the polyacrylic acid block.

Di-block copolymer 2: a polybutylacrylate-polyacrylic acid (PBA-b-PAA) block copolymer, having a weight-average molecular weight of 15,000 g/mol, comprising 70 wt % of the polybutylacrylate block and 30 wt % of the polyacrylic acid block.

Hydrophobic compound 1: a polybutylacrylate homopolymer having a weight-average molecular weight of 7,500 g/mol.

Hydrophobic compound 2: a polybutylacrylate polymer, comprising butylacrylate-derived units, and fluorescence-marked units, having a weight-average molecular weight of 3,500 g/mol.

Hydrophobic compound 3: CdSe nanoparticles (quantum dots) of diameter, having a surface of covered by a protecting layer of ZnS and a layer of TOPO (trioctylphosphine oxide) to make them oil-soluble.

### Examples 1-3

Procedure:

Stock solutions of di-block copolymer 1 in THF (99.9%, Sigma-Aldrich), 4 mg/ml, are prepared. Stock solutions of the hydrophobic compound 1 in THF (99.9%, Sigma-Aldrich), 4 mg/ml, are prepared.

The two solutions are mixed by vortexing at ratios different amounts of the hydrophobic compound solution, in relation with the amount of di-block copolymer solution: 3 wt %, 5 wt %, 30 wt %.

TABLE 1

| Example | Amount of di-block copolymer solution (wt %) |
|---|---|
| 1 | 3 |
| 2 | 5 |
| 3 | 30 |

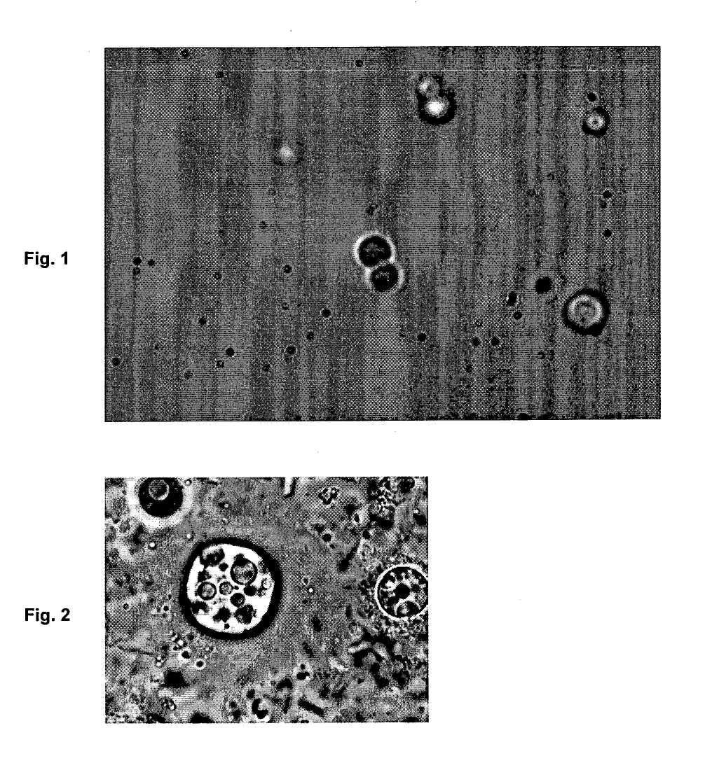

25 μl of each mixture is deposited in a glass vial. The THF solvent is then evaporated (4 h under vacuum), to obtain a thin polymer film at the bottom of the vial. The thin film is then rehydrated with 250 μl milli-Q water with Nitrogen bubbling to allow gentle stirring. The rehydration process lasts 1 hour. A suspension in water of vesicles is obtained, except for the 0 wt % comparative example. All the steps are carried out at room temperature. Optical micrographs of the vesicles is presented on FIG. 1 for example 2, and on FIG. 2 for example 3.

### Example 4

### Fluorescence Experiment—Hydrophilic Phase

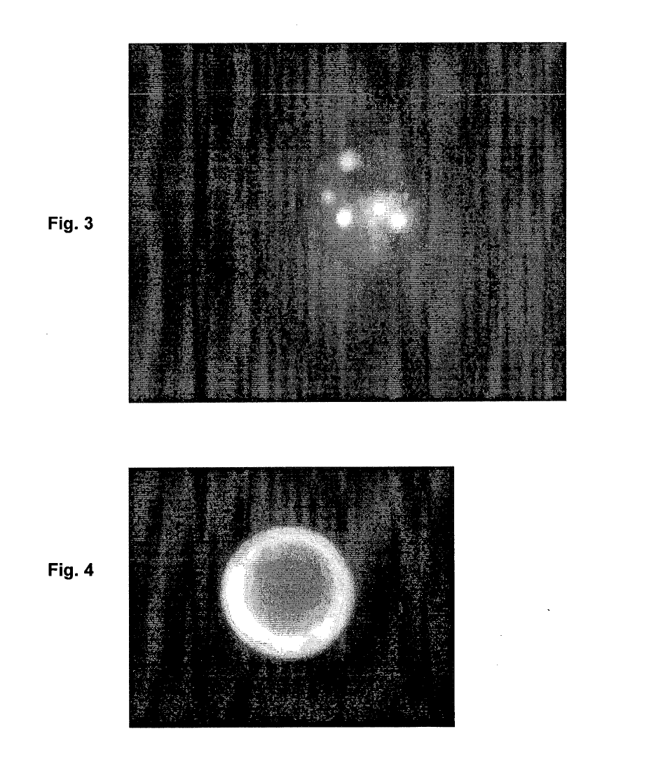

The process described for example 3 is carried out with adding 50 nM Dexran-Texas Red dye, 1 OK (Molecular Probes Inc.) in the milli-Q water used for film rehydration. A Fluorescence quenching of the aqueous exterior of the vesicles in the suspensions is achieved by the adding a specific anti-dye (anti-Texas Red, Molecular Probes, Inc.). For this purpose 20 μl of anti-Texas Red are added to 50 μl of the vesicle suspension. Incubation time of 15-20 min at room temperature is allowed for quenching to take place before imaging by Fluorescence microscopy. FIG. 3 is a fluorescence microscopy image of a vesicle obtained with 30 wt % of hydrophobic compound 1. FIG. 3 shows formation of a vesicle comprising water-based droplets inside a hydrophobic compound phase.

### Example 5

### Fluorescence Experiment—Hydrophobic Phase

The process described for example 1 is carried out, using di-block copolymer 1, and 10 wt % of a solution of hydrophobic compound 2.

FIG. 4 is a fluorescence microscopy image of a vesicle obtained. FIG. 4 shows that the hydrophobic compound is in the membrane of the vesicles.

### Example 6

2 μl of hydrophobic compound 3 nanoparticles, suspended in hexane, are mixed with 1 ml THF (tetrahydrofuran). The solution is afterwards diluted in milli-Q water to 1% and added to 2 mg of block copolymer 2 in a powder form.

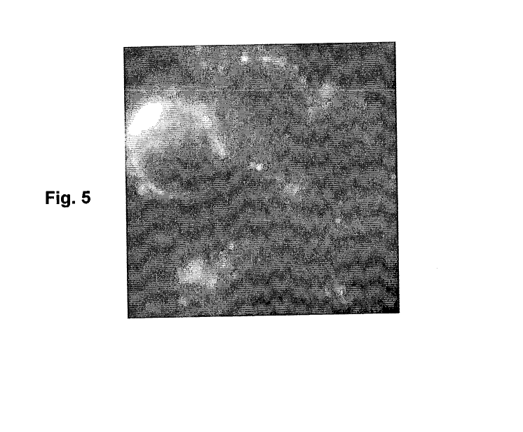

Vesicles are then formed by vortexing the solution during 5 minutes. FIG. 5 is a fluorescence microscopy image of vesicles. It shows that quantum dots are encapsulated into the vesicle membrane.

1. Vesicles comprising an external shell of a di-block copolymer comprising a hydrophilic block and a hydrophobic block, and at least one internal shell of the same or another di-block copolymer comprising a hydrophilic block and a hydrophobic block, the hydrophobic block of the external shell facing the hydrophobic block of the internal shell(s), further comprising a hydrophobic compound between the shells.

2. Vesicles according to claim 1, wherein the hydrophobic compound is a hydrophobic polymer.

3. Vesicles according to claim 2, wherein the hydrophobic block(s) and the hydrophobic polymer comprise repeating units, said units being the same.

4. Vesicles according to claim 1, wherein the hydrophobic compound is inorganic particles.

5. Vesicles according to claim 3, wherein:
the hydrophilic block comprises hydrophilic units, the hydrophobic block comprises hydrophobic units, the weight ratio between the amount of hydrophobic units and the hydrophilic units being comprised between 25/75 and 70/30, and
the weight amount of hydrophobic polymer, relating to the amount of di-block copolymer, is greater than or equal to 1%.

6. Vesicles according to claim 3, wherein:
the hydrophilic block comprises hydrophilic units, the hydrophobic block comprises hydrophobic units, the weight ratio between the amount of hydrophobic units and the hydrophilic units being comprised between 50/50 and 70/30, and
the weight amount of hydrophobic polymer, relating to the amount of di-block copolymer, is greater than or equal to 3%.

7. Vesicles according to claim 1, dispersed in an external hydrophilic medium, the hydrophilic block of the external shell facing said external hydrophilic medium, and comprising inside the internal shell(s) an internal hydrophilic medium, the hydrophilic block of the internal shell(s) facing said internal hydrophilic medium.

8. Vesicles according to claim 7, wherein the internal and external hydrophilic media are water or a composition comprising water.

9. Vesicles according to claim 1, further comprising a hydrophobic active dispersed in the hydrophobic compound.

10. Vesicles according to claim 1, comprising inside the internal shell(s) an internal hydrophilic medium, the hydrophilic block of the internal shell(s) facing said internal hydrophilic medium.

11. Vesicles according to clam 10 the internal hydrophilic medium is water or a composition comprising water.

12. Vesicles according to claim 9, wherein the hydrophilic medium comprises an active.

13. Vesicles according to claim 10, further comprising a hydrophobic active dispersed in the hydrophobic compound.

14. Vesicles according to claim 3, wherein the hydrophobic block is a polybutyl-acrylate block, the hydrophilic block is a polyacrylic-acid block, and the hydrophobic polymer is a polybutyl-acrylate homopolymer.

15. Vesicles according to claim 2, obtained by a process comprising the steps of:
a) depositing onto a surface a solution comprising the di-block copolymer(s) and the hydrophobic polymer, dissolved in a solvent,
b) evaporating the solvent to obtain a dried thin film comprising the di-block copolymer and the hydrophobic polymer, and
c) rehydrating the thin film.

16. Vesicles according to claim 15, wherein the process further comprises extruding through a membrane.

17. Vesicles according to claim 1, wherein the hydrophobic compound is a cross linkable polymer, said polymer being further cross-linked to control the permeability or the mechanical properties of the vesicles.

18. Vesicles according to claim 7, obtained by a process comprising the steps of:
a) depositing onto a surface a solution comprising the di-block copolymer and the hydrophobic polymer, dissolved in a solvent,
b) evaporating the solvent to obtain a dried thin film comprising the di-block copolymer and the hydrophobic polymer, and
c) rehydrating the thin film,
wherein the external hydrophilic medium and the vesicles form a triple emulsion comprising an internal hydrophilic phase dispersed in a hydrophobic phase, said hydrophobic phase being dispersed in an external hydrophilic phase, wherein:
the external hydrophilic phase comprises the external hydrophilic medium,
the hydrophilic phase comprises the hydrophobic compound between the shells, and
the internal hydrophilic phase comprises the internal hydrophilic medium.

19. Vesicles according to claim 18, wherein the internal and external hydrophilic media are water or a composition comprising water.

20. Vesicles according to claim 18, wherein:
the hydrophilic block comprises hydrophilic units, the hydrophobic block comprises hydrophobic units, the weight ratio between the amount of hydrophobic units and the hydrophilic units being comprised between 25/75 and 70/30, and
the amount of hydrophobic polymer is greater than or equal to 10%.

21. Vesicles according to claim 20, wherein:
the hydrophilic block comprises hydrophilic units, the hydrophobic block comprises hydrophobic units, the weight ratio between the amount of hydrophobic units and the hydrophilic units being comprised between 50/50 and 70/30, and
the amount of hydrophobic polymer is greater than or equal to 15%.
